(19) United States
(12) Patent Application Publication
(10) Pub. No.: US 2008/0160963 A1
(43) Pub. Date: Jul. 3, 2008

(54) Method of modifying ring tone

(76) Inventors: Ming Ai Chi, LaoShan District (CN); Feng Xu, LaoShan District (CN)

Correspondence Address: HARNESS, DICKEY & PIERCE, P.L.C., P.O. BOX 8910, RESTON, VA, 20195, US

(21) Appl. No.: 11/798,843

(22) Filed: May 17, 2007

(30) Foreign Application Priority Data
Dec. 29, 2006 (CN) 200610130914.5

(51) Int. Cl. H04M 3/02

(52) U.S. Cl. 455/412.2

(57) ABSTRACT

In an example embodiment, the method includes receiving a service request from a first user in association with a call request. The call request requests call origination to a second user, and the service request requests that a voice message of the first user be played by a communication device of the second user as a ring tone. The voice message of the first user is obtained in response to the service request. The method further includes downloading the obtained voice message to the second user as the ring tone in response to the service request.

### PRIORITY STATEMENT

This non-provisional application claims the benefit of priority under 35 U.S.C. § 119 to Chinese Patent Application No. 200610130914.5, filed on Dec. 29, 2006, the contents of which are herein incorporated by reference in its entirety.

### BACKGROUND OF THE INVENTION

In a conventional wireless system, when a first user calls a second user, the second user may choose not to answer the phone. The term “user” throughout the specification may mean a subscriber of a wireless communication service. The second user may be in a business meeting and ignore the phone call with the intention of returning the call after the meeting. The second user may ignore the phone call even knowing with the aide of a caller ID feature that the call is from a relative, friend, or business associate. Ignoring the phone call may be problematic if the call is an emergency. However, there is no current system or method for the second user to know that the phone call is an emergency. If a phone call is an emergency, the first user's only recourse may be to continue to call the second user until the second user answers the phone call.

In another scenario, the first user may call the second user, but the first user may attempt the call from a borrowed phone, a public phone, or a landline phone having a number not recognized by the second user. Again, the second user may ignore the phone call even if the call is from a family member, friend, or business associate, and even if the phone call is an emergency.

### SUMMARY OF THE INVENTION

In an example embodiment, the method includes receiving a service request from a first user in association with a call request. The call request requests call origination to a second user, and the service request requests that a voice message of the first user be played by a communication device of the second user as a ring tone. The voice message of the first user is obtained in response to the service request. The method further includes downloading the obtained voice message to the second user as the ring tone in response to the service request.

In another example embodiment, the method includes receiving a service request from a first user in association with a call request. The call request requests call origination to a second user, and the service request requests that a message of the first user be played by a communication device of the second user as a ring tone. A voice message of the first user is obtained in response to the service request. The method further includes determining whether the communication device of the second user supports downloading the voice message as a ring tone. If not, the voice message is converted to a text message, and the text message is downloaded to the communication device of the second user.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the example embodiments of the present invention.

FIG. 1 illustrates an IP multimedia subsystem (IMS) of an example embodiment of the present invention.

FIG. 2 illustrate a flow chart of a method of an example embodiment of the present invention.

FIG. 3 illustrate a flow chart of a method of another example embodiment of the present invention.

FIG. 4 illustrate a flow chart of a method of yet another example embodiment of the present invention.

FIG. 5 illustrate a flow chart of a method of still another example embodiment of the present invention.

### DETAILED DESCRIPTION OF EXAMPLE EMBODIMENTS

Although example embodiments of the present invention will be described with reference to an IP multimedia subsystem (IMS), a person of ordinary skill will recognize the example embodiments of the present invention may apply to other types of telecommunication systems.

There are generally two types of wireless communication systems, circuit-switched (CS) and packet-switched (PS) systems.

In typical circuit-switched wireless communication systems, a Mobile Switching Center (MSC) connects a landline Public Switched Telephone Network (PSTN) system to the wireless communication system. The MSC is typically split into an MSC server and a Media Gateway (MGW), and incorporates the Bearer Independent Call Control (BICC) or ISDN User Part (ISUP) call control protocol for call delivery between the MSCs.

One approach to introducing Internet Protocol (IP) Multimedia services for Universal Mobile Telecommunications Service (UMTS) and Code Division Multiple Access (CDMA) Third generation (3G) systems is an IP Multimedia Subsystem (IMS), which is comprised of a set of IP-connected network entities within the IMS using packet-switched services. These network entities provide IP Multimedia features and services using the Session Initiation Protocol (SIP) as the primary vehicle for call control.

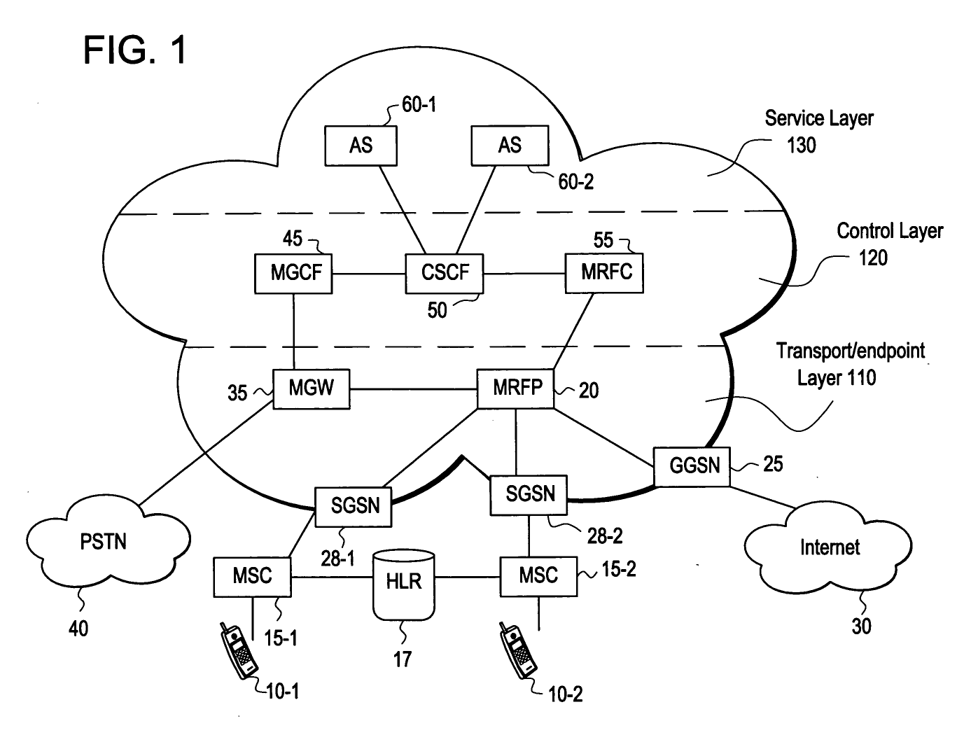

FIG. 1 illustrates a conventional IMS 100. The IMS 100 may include a transport/endpoint layer 110, a control layer 120, and a service layer 130. The transport/endpoint layer 110 may include a multimedia resource function processor (MRFP) 20, a media gateway (MGW) 35, etc. The MRFP 20 mixes media streams and also transcodes the streams. The MRFP 20 may be connected to the Internet 30 via a gateway support node (GGSN) 25. Basically, the GGSN 25 is an interface between the IMS 100 and the Internet 30. FIG. 1 illustrates an example where the first and second mobile stations 10-1, 10-2 are connected to the MRFP 20 via respective first and second mobile service switching centers (MSC) 15-1, 15-2 and the SGSNs (serving GPRS support node) 28-1, 28-2. The SGSNs 28-1, 28-2 keep track of the location of the mobile stations 10-1, 10-2, respectively, and perform security functions and access control. The mobile stations 10-1, 10-2 may be a communication device capable of receiving video, audio, text data, etc. The first and second MSCs 15-1, 15-2 may be connected to a home location register (HLR) 17. The HLR 17 is the main database of permanent user (subscriber) information for a mobile network, and contains pertinent user information, including address, account status, and preferences. The MGW 35 may be connected to a public switched telephone network (PSTN) 40. The MGW 35 acts as a translation unit between the PSTN 40 and IMS 100. The MGW 35, the Internet 30, and the first and second mobile stations may be linked by the real time transport protocol (RTP).

The control layer 120 may include a media gateway control function (MGCF) 45, a call session control function (CSCF) 50, a multimedia resource function controller (MRFC) 55, etc. The MGCF 45 generally terminates signaling and provides call control interface and translation between the IMS 100 and the PSTN 40. The CSCF 50 generally performs signaling operations for call session control. The CSCF 50 also manages SIP sessions and coordinates with other network entities for session control, service control, and resource allocation. The MRFC 55 generally controls the media-stream resources in the MRFP 20.

The service layer 130 may include a plurality of application servers (AS) 60, which may be connected to the CSCF 50. The AS 60 may be a WebLogic SIP Server, which executes IMS applications and services by manipulating SIP signaling and interfacing with other systems. The AS 60 may also include HTTP capabilities allowing it to also perform the role of a content server for resources such as media files and VoiceXML application scripts. The AS 60 may also offer a programming language and framework for creating new services, for example Java SIP and HTTP Servlets.

It is well known that the IMS 100 may contain additional elements not illustrated in FIG. 1 nor disclosed herein. For the sake of clarity, only those elements and features for understanding example embodiments of the present invention have been illustrated and described in detailed.

Example embodiments of the present invention provide a method of modifying a ring tone of a receiving subscriber's mobile station. A caller may modify the ring tone of the mobile station of the person the caller is trying to reach by modifying the ring tone into a voice message.

In an example embodiment of the present invention, a first user may attempt to call a second user. However, for whatever reason, the second user may refuse to answer the phone. After several attempts, the first user may dial the second user's number but with a prefix or a suffix. The prefix or suffix triggers a service request and/or call origination request. For example, if the second user mobile station's number is “703-555-5555,” the first user may dial “*22-703-555-5555.” Prefix “*22” is just an example, and other prefixes may be used. It is also contemplated that a suffix may be used, or that other signaling methods for signaling or triggering the service of the example embodiments of the present invention may be used. In this example, dialing the extra prefix numbers in addition to the second user's mobile number triggers the service of the example embodiments of the present invention.

Accordingly to one embodiment, triggering the service results in the first user being prompted to record a short message. As prompted, the first user records, for example, the following message: “This is Lucy. It's an emergency, please answer the phone.” When the phone call is routed to second user, the second user's mobile station, instead of playing the standard mobile telephone ring tone, will play: “This is Lucy. It's an emergency, please answer the phone.”

With reference with FIG. 1, a method of modifying the ring tone of a receiving user's mobile telephone will be described in greater detail.

When the first user dials (calls) the second user's telephone number with the prefix, for example, “*22,” a first mobile service switching center (MSC) 15-1 will activate the CSCF 50 in the IMS 100. The CSCF 50 will invite the first user to record a message. The MRFP 20 records and saves the recorded message.

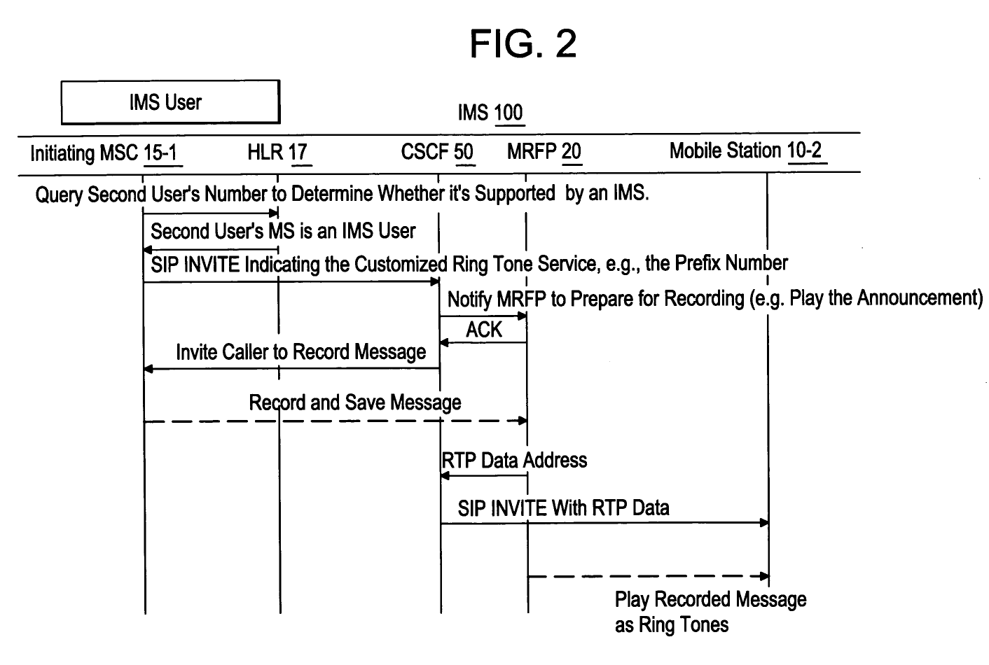

In more detail with reference to FIG. 2, the first MSC 15-1 may first query the HLR 17 to determine whether the second user's mobile station 10-2 is supported by the IMS 100. Assuming that the second user's mobile station 10-2 is supported by the IMS 100, the first MSC 15-1 sends an initial session initiation protocol (SIP) invite message with a ring tone request to the IMS 100, e.g., CSCF 50. The customized ring tone service may be the prefix numbers. The CSCF 50 notifies the MRFP 20 to prepare to record a message (voice data). The MRFP 20 sends an ACK to the CSCF 50, and the CSCF 50 invites the first user to record a message. The MRFP 20 records and saves the message made by the first user as a real time transport protocol (RTP) data stream. The MRFP 20 sends back a RTP data address to notify the CSCF 50 that the RTP data stream is ready for transmission. The CSCF 50 notifies the second user's mobile station 10-2 with a SIP INVITE message and the RTP stream data. The RTP stream data is transmitted and played by the second user's mobile station 10-2 as a ring tone. For example, the second user's mobile station plays the recorded message: “This is Lucy. It's an emergency, please answer the phone.”

It is assumed that the second user's mobile station 10-2 has the function to recognize and play the RTP stream data as ring tone. The CSCF 50 sends the RTP stream data, the second user's mobile station 10-2 recognizes the RTP stream data requires the second user's mobile station 10-2 to change its normal ring tone with the RTP stream data. The second user's mobile station 10-2 may use hardware or software to recognize and play the RTP stream data.

In another example embodiment of the present invention. A user may have the option of pre-recording a personalized message. In other words, instead of recording personalized messages each time the user calls another party, the user may pre-record one or more personalized messages, which may be prompted when the user calls the other party. The pre-recorded message may be recorded via the Internet or a service accessible by a mobile station.

A user may pre-record several messages. For example, the user may pre-record the following messages:
1. This is Lucy, please answer the phone;
2. Mom, it's me, please answer the phone; or
3. Dear customer, my name is Lucy. I am returning your call in regards to your interest in our product. Please answer the phone.

The user pre-records and the pre-recorded messages are saved on a multimedia resource function processor (MRFP) 20 illustrated in FIG. 1.

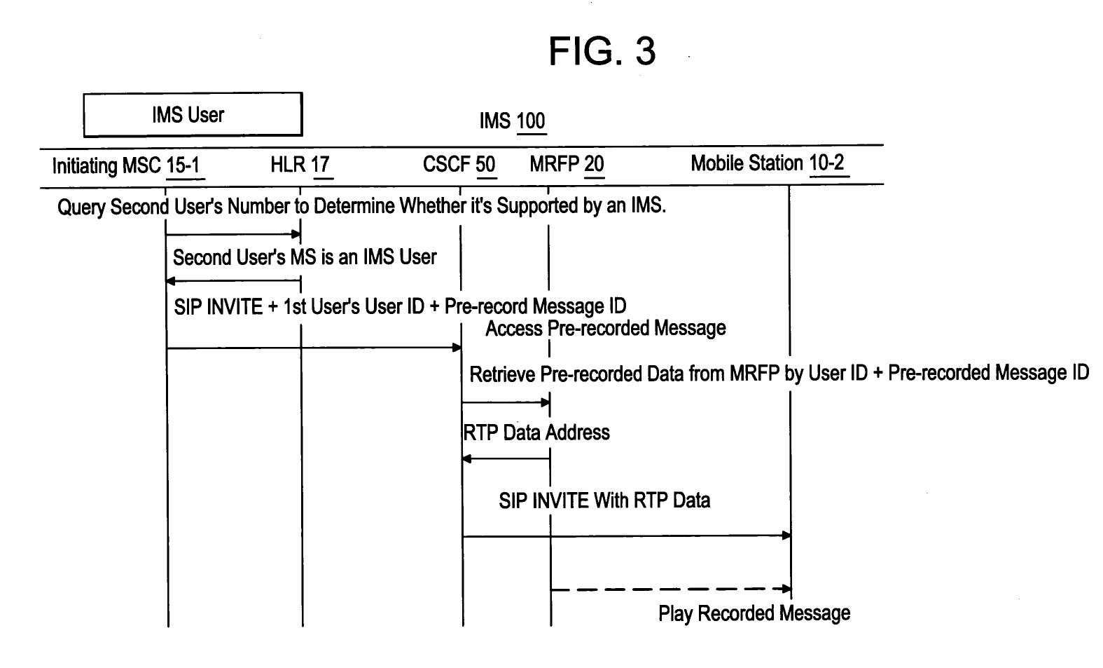

For example and with reference to FIG. 3, a first user calls a second user. Again, assume that the second user's mobile station number is “703-555-5555.” The first user, in addition to dialing the second user's mobile number, may also dial prefixes “*21-1-113.” Prefix “*21” may trigger access to the pre-recorded service. The “1” following the “*21” in the prefix may designate the pre-recorded message, and the prefix “113” may correspond to the first user's service ID number.

The first MSC 15-1 may first query the HLR 17 to determine whether the second user's mobile station 10-2 is supported by the IMS 100. Assuming that the second user's mobile station 10-2 is supported by the IMS 100, the first MSC 15-1 will send an initial SIP INVITE message, a calling user's service ID number, and a pre-recorded message ID to the IMS 100, e.g., CSCF 50.

Then, the CSCF 50 will receive the pre-recorded message from the MRFP 20. For example, the MRFP 20 sends an RTP data address to the CSCF 50, and CSCF uses the address to access the RTP stream. The CSCF 50 notifies the second user's mobile station 10-2 with a SIP INVITE and the RTP stream. The transmitted RTP stream is played by the second user's mobile station 10-2 as a ring tone.

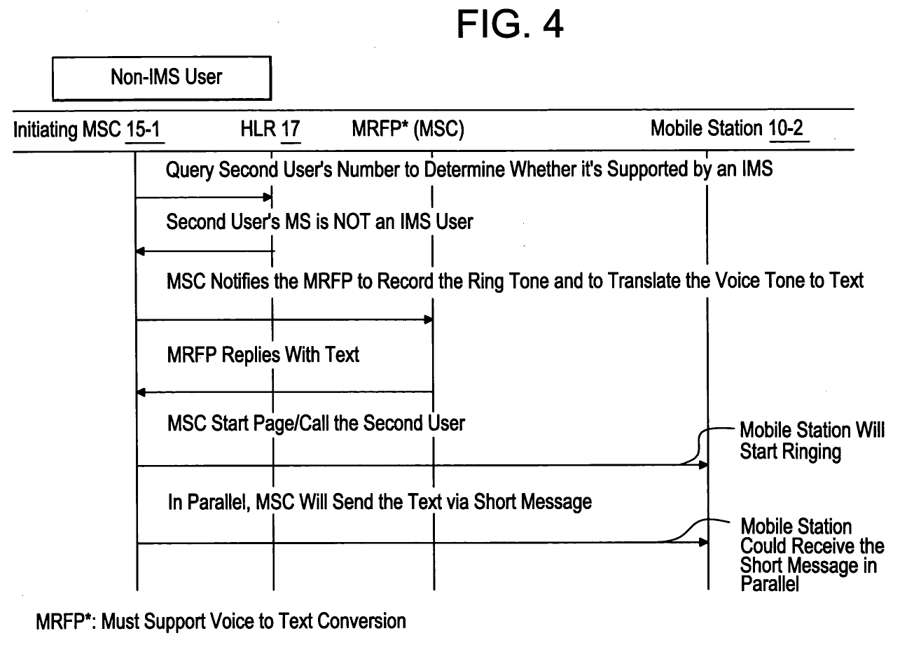

FIG. 4 illustrates another example embodiment of the present invention. This example assumes that the second user's mobile station 10-2 or subscription does not support the customized ring tone service and/or the second user's mobile station 10-2 is not supported by the IMS 100.

If a first user attempts to call a second user, but the second user does not answer the mobile station, the first user may in addition to re-dialing the second user's mobile number, dial prefix “*21.” As discussed above, prefix “*21” triggers access to the customized ring tone service.

The first MSC 15-1 queries the HLR 17 to determine whether the second user's mobile station 10-2 is supported by the IMS 100. Here, it is assumed that the second user's mobile station 10-2 is not supported by the IMS 100. The first MSC 15-1 may, however, include a multimedia resource function processor (MRFP), and the MRFP has the capability to translate voice data into text.

Similar to example embodiments above, the first user may be invited to leave a voice recorded message by the first MSC 15-1. In this example embodiment, the MRFP of the first MSC 15-1 will record the voice message, and in addition, translate the voice message into text. Then the first MSC 15-1 will call/page the second user's mobile station 10-2. The first MSC 15-1 may also in parallel send the text message via a short message to the second user's mobile station 10-2. The second user's mobile station 10-2 may ring (normal ring) and display the text message in parallel.

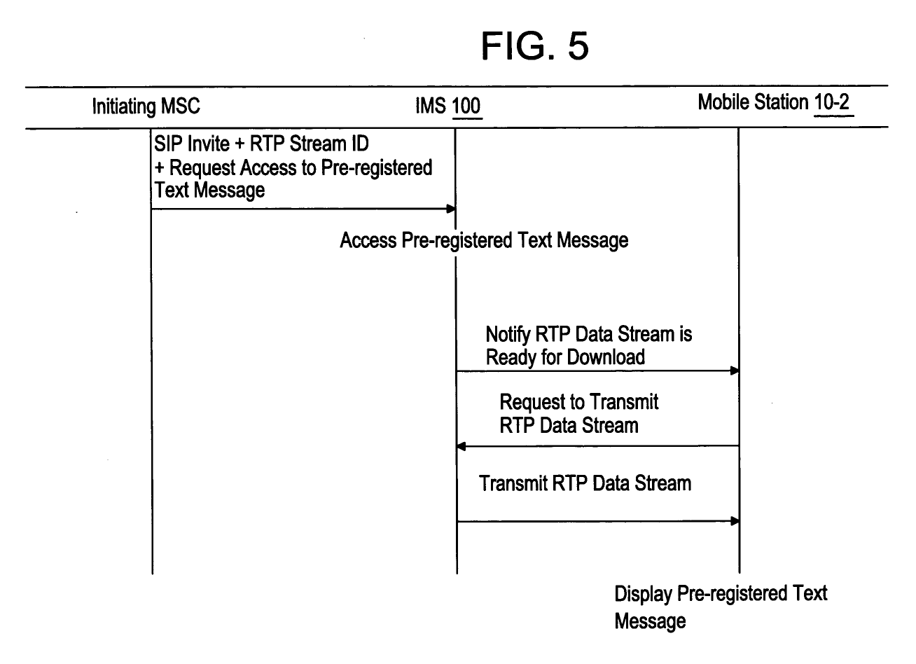

FIG. 5 illustrates another example embodiment of the present invention. Similar to the example embodiment illustrated above with respect to FIG. 4, this example also assumes that the second user's mobile station 10-2 or subscription does not support the ring tones service and/or the second user's mobile station 10-2 is not supported by the IMS 100.

The first MSC 15-1 queries the HLR 17 to determine whether the second user's mobile station 10-2 is supported by the IMS 100. Here, it is assumed that the second user's mobile station 10-2 is not supported by the IMS 100. It is also assumed that a first MSC 15-1 includes a multimedia resource function processor (MRFP).

Once the first MSC 15-1 determines that the second user's mobile station is not supported by the IMS 100, at this point, the first user may access other services by pressing a number(s) as prompted, or the first user may access the text service by entering user ID numbers and an message ID number, for example, prefixes. The selected service may allow the first user access to a pre-registered text and/or voice message(s). The pre-registered text/voice message may be registered via the Internet or a service accessible by a mobile station. If the pre-registered message is a voice message, the first MSC 15-1 may translate the voice message into a text message. The text/voice massage may be, “This is Lucy, please answer the phone.” When a call is made to the second user, the second user's mobile station 10-2 will display the text “This is Lucy, please answer the phone” in lieu or in addition to vibrating and/or ringing. In detail with reference to FIG. 5, the first MSC 15-1 notifies its MRFP to retrieve the pre-registered text based, for example, on the first user's ID and message ID. Alternatively, as described above with respect to one of a plurality of pre-recorded voice messages may be selected, and the selected pre-recorded voice message converted to a text message.

Then the first MSC 15-1 will call/page the second user's mobile station 10-2. The first MSC 15-1 may also in parallel send the text message via a short message to the second user's mobile station 10-2. The second user's mobile station 10-2 may ring (normal ring) and display the text message in parallel.

The example embodiments of the present invention being thus described, it will be obvious that the same may be varied in many ways. For example, while an example implementation of the present invention has been described with respect to an IP multimedia subsystem (IMS), it will be appreciated that the present invention is applicable to other telecommunication systems. Such variations are not to be regarded as a departure from the invention, and all such modifications are intended to be included within the scope of the invention.

What is claimed is:

1. A method, comprising:
receiving a service request from a first user in association with a call request, the call request requesting call origination to a second user, and the service request requesting that a voice message of the first user be played by a communication device of the second user as a ring tone;
obtaining the voice message of the first user in response to the service request; and
downloading the obtained voice message to the second user as the ring tone in response to the service request.

2. The method of claim 1, wherein the message is embodied in a real time transport protocol (RTP) data stream.

3. The method of claim 1, wherein the service request is a prefix to the call origination request.

4. The method of claim 1, wherein the obtaining step records the voice message from the first user in response to the service request.

5. The method of claim 1, wherein the obtaining step selects one of a plurality of pre-recorded voice messages from the first user.

6. The method of claim 5, wherein the obtaining step determines which of the plurality of pre-recorded voice messages to select based on the service request.

7. The method of claim 1, further comprising:
determining whether the communication device of the second user supports the downloading step; and
performing the obtaining and downloading steps if the determining step determines the communication device of the second user supports the downloading step.

8. A method, comprising:
receiving a service request from a first user in association with a call request, the call request requesting call origination to a second user, and the service request requesting that a message of the first user be played by a communication device of the second user as a ring tone;
obtaining a voice message of the first user in response to the service request; and
determining whether the communication device of the second user supports downloading the voice message as a ring tone;
converting the voice message to a text message if the determining step determines the communication device of the second user does not support downloading the voice message as a ring tone; and
downloading the text message to the communication device of the second user.

9. The method of claim 8, wherein the service request is a prefix to the call origination request.

10. The method of claim 8, wherein the obtaining step records the voice message from the first user in response to the service request.

11. The method of claim 8, wherein the obtaining step selects one of a plurality of pre-recorded voice messages from the first user.

12. The method of claim 11, wherein the obtaining step determines which of the plurality of pre-recorded voice messages to select based on the service request.

13. The method of claim 8, further comprising:
downloading the obtained voice message to the second user as the ring tone if the determining step determines that the communication device of the second user supports downloading the voice message as a ring tone.
